(19) United States
(12) Patent Application Publication
(10) Pub. No.: US 2012/0202121 A1
(43) Pub. Date: Aug. 9, 2012

(54) HIGH VOLTAGE BATTERY FOR A LITHIUM BATTERY

(75) Inventor: Monique Nathalie RICHARD, Ann Arbor, MI (US)

(73) Assignee: Toyota Motor Engin. & Manufact. N.A.(TEMA), Erlanger, KY (US)

(21) Appl. No.: 13/020,854

(22) Filed: Feb. 4, 2011

(51) Int. Cl. H01M 10/056

(52) U.S. Cl. 429/326; 429/331; 429/207

(57) ABSTRACT

The present invention provides a electrolyte solution, particularly useful for lithium batteries that includes succinonitrile and a co-solvent that has improved conductivity and, in turn, better battery performance.

### BACKGROUND OF THE INVENTION

1. Field of the Invention

The present invention provides an electrolyte solution, particularly useful for lithium batteries that includes succinonitrile and a co-solvent that has improved conductivity and, in turn, better battery performance.

2. Description of the Related Art

Lithium ion batteries have been in commercial use since 1991 and have been conventionally used as power sources for portable electronic devices. See, e.g., U.S. 2009/0092902. The technology associated with the construction and composition of the lithium ion battery (LIB) has been the subject of investigation and improvement and has matured to an extent where a state of art LIB battery is reported to have up to 700 Wh/L of energy density. Technologies which can offer battery systems of higher energy density are under investigation.

To increase the electric only range of vehicles, the on-board battery energy must be increased.

One way to accomplish this is by incorporating more energetic materials into the battery. For example, higher voltage cathode material could be used, but only if a compatible electrolyte can be developed. One candidate for a high voltage electrolyte is SCN. Ali et al have measured its voltage stability in excess of 5.5V (compared to the 4.1 V of today's traditional LiB).

WO 2008/138132 A1 to Abouimrane, Ali et al describes the utility of dinitrile based liquid electrolytes and exemplifies SCN that can be combined with a co-solvent, such as propylene carbonate (see pages 5 and 6) in a ratio of 1:99 to 99:1. There is a specific example where the ratio is 1:1 (see page 7, legend to FIG. 4). Li BOB is suggested as an example of an ionic salt to be used in the liquid electrolyte (see page 6, lines 4-6). The amount of dinitrile is suggested to range from 10 to 90% v/v with preferred ranges at 16-80 and 25-75% v/v (see page 5, lines 21-23).

U.S. 2010/0119951 to Abouimrane, Ali et al describes LiBOB and SCN in a crystal plastic electrolyte (see pages 1-2, paragraph [0010] and page 3, paragraphs [0041] and [0042]).

U.S. 2009/0068562 to Yew, Kyoung-Han et al generally suggests the combination of lithium salts and a non-aqueous organic solvent (see page 5, paragraph [0055]). This publication suggests LiBOB as a lithium salt (see page 5, paragraph [0057] and propylene carbonate as a solvent (see page 5, paragraph [0059]). This publication also suggests the inclusion of SCN (see Example 8 on page 7) at 5 wt % combined with a 1:1:1 ratio of propylene carbonate, diethyl carbonate, and ethylene carbonate.

U.S. 2008/0248397 to Jung, Euy-Young et al describes an electrolyte for lithium battery and suggests a lithium salt and a nitrile based compound such as SCN (see page 1, paragraphs [0007] and [0012]). The amount of nitrile is taught in an amount of 0.005 to 10 wt % based on the total weight of the electrolyte (see pages 2-3, paragraph [0037]). This publication also suggests the inclusion of non-aqueous organic solvents such as propylene carbonate (see page 3, paragraph [0039]) and also suggests that the lithium salt can be LiBOB (see page 3, paragraph [0046]).

U.S. 2008/0118847 to Jung, Euy-Young et al describes an electrolyte for a lithium battery including a lithium salt, such as LiBOB (see page 3, paragraph [0032] and [0044]) including SCN (see page 3, paragraph [0033]) and propylene carbonate (see page 3, paragraph [0036]). The amounts of the additive (SCN) can range from 0.001 wt % to 10 wt % (see page 3, paragraph [0034]) and suggests ranges of carbonate solvent mixtures of 1:1 to 1:9 (see page 3, paragraph [0038]). See also Example 1 on page 4, paragraphs [0060] to [0062].

U.S. 2008/0118846 to Lee, Jong-Hwa et al describes a lithium battery including SCN in amounts ranging from 0.01 to 10 wt % (see page 1, paragraphs [0014] and [0015]) and also suggest the inclusion of organic solvents such as propylene carbonate (see page 1, paragraph [0017]). LiBOB is suggested as an exemplary lithium salt (see page 2, paragraph [0025]).

U.S. 2008/0102369 to Sakata, Hideo et al describes a nonaqueous secondary battery that can include a lithium electrolyte salt (see page 2, paragraph [0025]) and a nitrile compound such as SCN in an amount of at least 0.005% by weight and suggest the maximum amount that should be include is 1% by weight (see page 3, paragraph [0029] and [0031]). This publication also suggests that the solvent can be and/or include propylene carbonate (see page 2, paragraph [0023]).

U.S. 2006/0024584 to Kim, Dong M. et al describes a lithium secondary battery that can include a nitrile additive such as SCN in an amount of 0.1 to 10 wt % (see pages 2-3, paragraph [0032, [0034] and [0035]]. This publication also suggests that the organic solvent can be propylene carbonate (see page 3, paragraph [0041]).

U.S. 2004/0013946 to Abe, Koji et al describes a lithium battery combining a non-aqueous solvent such as propylene carbonate with a nitrile such as SCN (see page 1, paragraph [0011] and page 2, paragraphs [0015], and [0022]). The amount of the dinitrile is suggested to be present in an amount of 0.001 to 10 wt % (see page 2, paragraph [0017]).

U.S. Pat. No. 7,226,704 to Panitz, Jan-Christoph et al generally describes lithium salts such as LiBOB (see col. 2, line 47) with 35 to 55 wt % of carbonates such as propylene carbonate (see col. 2, lines 50-52 and col. 3, line 14) with dinitriles in an amount of 5 to 40 wt % (see col. 2, lines 533-60 and col. 3, lines 53-54).

U.S. Pat. No. 6,506,516 to Wietelmann, Ulrich et al describes the production of LiBOB and suggests that the lithium salt can be included in batteries (see, e.g., col. 1, lines 5-8).

CA 2435218 A1 to Abu-Lebdeh, Yaser et al describes a plastic crystal electrolyte that can include lithium salt and succinonitrile (see page 9, Example 1).

However, improvements in performance remains in high demand for the various tasks for which lithium batteries are employed. Further, electrolytes with high oxidative stability are required to significantly increase the energy density of lithium batteries that then permit the use of high V cathode materials.

### SUMMARY OF THE INVENTION

The present invention is based on the surprising discovery that an electrolyte for a Li battery, particularly one using Li BOB as the ionic salt, which comprises the combination of succinonitrile (SCN) and up to 40% (by weight) of propylene carbonate, by itself or in combination with additional secondary solvents yields improved conductivity thereby enhancing battery performance in terms of capacity, power and resistance. In particular, the improvement of conductivity at temperatures less than 40° C. is attained.

Accordingly, one embodiment of the present invention is an electrolyte, comprising a lithium salt and from 20 to 80 wt % succinonitrile and 5 to 40 wt % of at least one co-solvent.

Another embodiment of the present invention is a rechargeable lithium battery, comprising an anode; a cathode; and an electrolyte; wherein the electrolyte comprises a lithium salt and from 20 to 80 wt % succinonitrile and 5 to 40 wt % of at least one co-solvent.

### BRIEF DESCRIPTION OF THE DRAWINGS

FIG. 1 depicts log conductivity as a function of temperature for differing compositions as is described in the Examples.

### DETAILED DESCRIPTION OF THE INVENTION

The electrolyte of the present invention includes a lithium salt, succinonitrile (as used herein defined as a solvent even though it is solid at room temperature) and at least one co-solvent, preferably propylene carbonate, by itself or in combination with other secondary or co-solvents.

The purpose of the co-solvent is to improve the low-temperature performance of the SCN-based electrolyte, without reducing the voltage stability of the resulting electrolyte solution. Ideally, an electrolyte solution with a voltage stability in excess of 5.5V would be maintained, while increasing the conductivity at room temperature and below to the milli-Siemens range.

In one embodiment, as small an amount of co-solvent as possible is added as the co-solvents with good low temperature performance typically have poor stability at high voltage. Hence the design of the ideal electrolyte would balance the high voltage stability with conductivity.

In addition to propylene carbonate, additional co-solvents may be organic, inorganic or a mixture thereof. The co-solvent may be, for example, dimethyl carbonate (DMC), diethyl carbonate (DEC), ethylene carbonate (EC), methyl propyl carbonate (MPC), dimethyl formamide (DMF), tetrahydrofuran (THF), 2-methyl tetrahydrofuran, 2-chloromethyl tetrahydrofuran, methyl formate, methyl acetate, γ-butyrolactone (BL or γ-BL), acetonitrile (ACN), 3-methoxypropionitrile (MPN), tetramethylene sulfone ((CHj)₄SO₂), dimethyl sulfoxide (DMSO), tetraethylsulfonamide (TESA), dimethyl sulfite, sulfolane (SL), 1,3-dioxolane, dimethoxyethane (DME), sulfur dioxide (SO₂), thionyl chloride (SOCl₂), sulfuryl chloride (SO₂Cl₂) or a mixture thereof. In one embodiment, the co-solvent is propylene carbonate.

The co-solvent including propylene carbonate, individually or mixtures thereof, is present in an amount of 5 to 40 wt %, inclusive of from 5 to 20 wt %, 10 to 20 wt %, 15 to 20 wt % and all values and ranges there between, e.g., 7, 12, 16, 19, 25, 30, 32, 35, and 38. In one embodiment, a mixture of co-solvents is used. In one embodiment, its desirable to minimize the amount of co-solvent as these have lower voltage stability. The succinonitrile is present in the electrolyte in an amount of 20 to 80 wt %, inclusive of 30 to 60 wt % succinonitrile, 40 to 50 wt % succinonitrile, and all values and ranges there between, e.g., 25, 27, 32, 35, 38, 41, 43, 45, 48, 52, 55, 59, 63, 65, 68, 70, 73, 75, 77 and 79.

Examples of suitable lithium salts are lithium bioxalato borate salt (Li[C₂O₄]₂B), lithium bis-trifluoromethanesulphonylimide (Li(CF₃SO₂)₂N), lithium bis-perfluoroethylsulphonylimide (Li(C₂F₅SO₂)₂N), lithium difluoro(oxalato)borate (LiC₂O₄BF₂), lithium tetrafluoroborate (LiBF₄), lithium hexafluorophosphate (LiPF₆), LiPF₃ (CF₂CF₃)₃, lithium thiocyanate (LiSCN), lithium triflate (LiCF₃SO₃), lithium tetrafluoroaluminate (LiAlF₄), lithium perchlorate (LiClO₄), lithium dinitramide (LiN(NO₂)₂), LiB₁₂F₁₂₋ₓHₓ, and mixtures thereof. In one embodiment, the lithium salt is lithium bioxalato borate. The lithium salt may be present in the electrolyte in any suitable amount, for example, in an amount of from 1-20 mol %, inclusive of all values and ranges there between, including 2, 4, 5, 7, 9, 12, 15, 17, and 19.

The present invention also provides an electrochemical device, e.g., a rechargeable lithium battery that includes the electrolyte composition described herein. As is well known in the art of lithium batteries, the battery includes, in addition to the electrolyte, an anode and a cathode.

It is also well known that the anode in a LiB typically includes to form a solid electrolyte interface (SEI) in order to function in an LiB. Traditionally, LiB electrolytes contain a film forming additive to most effectively and efficiently form this film. The electrolyte of this invention may further include such an additive. In certain embodiments of the present invention, the additive for forming a solid electrolyte interface film on the anode is present in amounts of about 0.2 to 5 wt %, including 0.5, 1, 1.5, 2, 2.5, 3, 3.5, 4, 4.5 and all values and ranges there between. Non-limiting examples of the additive for forming a solid electrolyte interface film on the anode are vinylene carbonate, vinylethelene carbonate, LiPF₆, LiBOB, and combinations thereof.

The electrochemical device can be used in other devices such as rechargeable consumer electronics, automotive applications (e.g., gas-hybrid vehicles) and in other commercial applications where a rechargeable device is useful.

### Examples

The electrolyte was made by:
1) the SCN is solid at RT. An appropriate amount of SCN is weighed out.
2) Process 1
   a. The SCN is melted, by placing the SCN on a hot plate at a maximum set point of 70° C.
   b. The salt and co-solvent are added once the SCN is melted.
   c. The mixture is kept at temperature on the hot plate and stirred
3) Alternately, the salt and the co-solvent are added to the solid SCN.
   a. The combination is stirred

When making the battery, it is necessary to select a separator which wets using the electrolyte. A traditional tri-layer PE/PP/PE is not wettable by SCN.

For proper wetting, the separator must be impregnated with the liquid electrolyte (in one example, when the co-solvent amount was low, the SCN mixture solidified at RT). This can be done by running the separator through the electrolyte and wicking off excess; or by adding a controlled amount of electrolyte (ex, using warm pipette) to the test cell.

When performing tests with active electrodes, for example carbon as the anode and/or a transition metal oxide as the cathode, it is necessary for the electrolyte to enter the pores of these electrode structures. This can most easily be accomplished by warming the electrodes so that the electrolyte remains liquid and flows into the electrolyte porosity.

Failure for the electrolyte to remain liquid, or to have a sufficiently low viscosity, will impact performance. As a result, the methods for cell assembly are important.

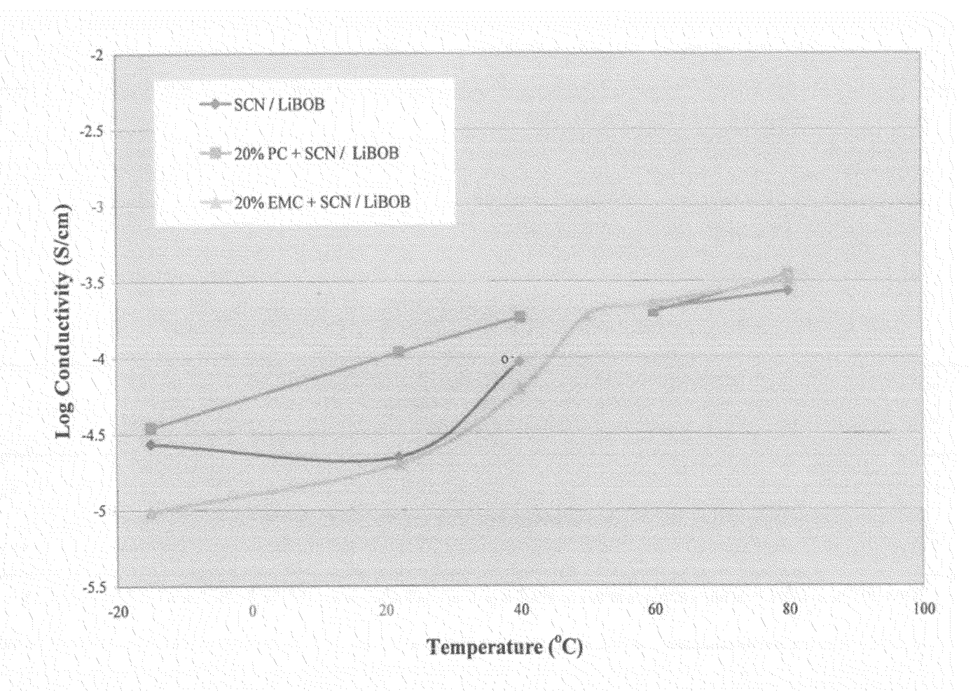

An electrolyte was made by combining succinonitrile (SCN) and 20% of either propylene carbonate (PC) or ethyl methyl carbonate (EMC). To this 4 mol % of LiBOB was added and stirred until the LiBOB was completely dissolved. The electrolyte solution was tested for conductivity by adding the solution to the separator of a test cell (that included from bottom to top: a case, separator, SUS spacer, spring, gasket and cover). The electrodes were SUS/SUS. Impedance spectroscopy was used to measure resistance and subsequently calculate conductivity. Impedance spectra are measured at different temperatures to produce the test results shown in FIG. 1.

The results shown in FIG. 1 demonstrate that the 20% PC-SCN composition has a four times increase in conductivity at 22° C. and a 2 times increase in conductivity at −18° C. The results also show that the combination of PC-SCN had a more pronounced improved effect when compared to the combination of SCN and EMC.

Obviously, numerous modifications and variations of the present invention are possible in light of the above teachings. It is therefore to be understood that within the scope of the appended claims, the invention may be practiced otherwise than as specifically described herein.

1. A rechargeable lithium battery, comprising
an anode;
a cathode; and
an electrolyte;
wherein
the electrolyte comprises a lithium salt and from 20 to 80 wt % succinonitrile and 5 to 40 wt % of a one co-solvent composition comprising propylene carbonate and, optionally at least one additional co-solvent.

2. The rechargeable lithium battery of claim 1, wherein the electrolyte further comprises an additive for formation of a solid electrolyte interface film on the anode.

3. The rechargeable lithium battery of claim 2, wherein the additive for formation of a solid electrolyte interface film on the anode is present in an amount of 0.2 to 5 wt %.

4. The rechargeable lithium battery of claim 2, wherein the additive for formation of a solid electrolyte interface film on the anode is vinylene carbonate, vinylethelene carbonate, LiPF6, LiBOB, or a combination thereof.

5. The rechargeable lithium battery of claim 1, comprising from 5 to 20 wt % of the co-solvent composition.

6. The rechargeable lithium battery of claim 1, comprising from 10 to 20 wt % of the co-solvent composition.

7. The rechargeable lithium battery of claim 1, comprising from 15 to 20 wt % of the co-solvent composition.

8. The rechargeable lithium battery of claim 1, wherein the co-solvent composition comprises at least one additional co-solvent.

9. The rechargeable lithium battery of claim 1, comprising 30 to 60 wt % succinonitrile.

10. The rechargeable lithium battery of claim 1, comprising 40 to 50 wt % succinonitrile

11. The rechargeable lithium battery of claim 1, wherein the lithium salt is lithium bioxalato borate.

12. The rechargeable lithium battery of claim 1, wherein the lithium salt is present in an amount from 1 to 20 mol %.

13. An electrolyte, comprising a lithium salt and from 20 to 80 wt % succinonitrile and 5 to 40 wt % of at least one co-solvent composition comprising propylene carbonate, and optionally at least one additional co-solvent.

14. The electrolyte of claim 13, further comprising an additive for formation of a solid electrolyte interface film on the anode.

15. The electrolyte of claim 14, wherein the additive for formation of a solid electrolyte interface film on the anode is present in an amount of 0.2 to 5 wt %.

16. The electrolyte of claim 14, wherein the additive for formation of a solid electrolyte interface film on the anode is vinylene carbonate, vinylethelene carbonate, LiPF6, LiBOB, or a combination thereof.

17. The electrolyte of claim 13, comprising from 5 to 20 wt % of the co-solvent composition.

18. The electrolyte of claim 13, comprising from 10 to 20 wt % of the co-solvent composition.

19. The electrolyte of claim 13, comprising from 15 to 20 wt % of the co-solvent composition.

20. The electrolyte of claim 13, wherein the co-solvent composition comprises at least one additional co-solvent.

21. The electrolyte of claim 13, comprising 30 to 60 wt % succinonitrile.

22. The electrolyte of claim 13, comprising 40 to 50 wt % succinonitrile

23. The electrolyte of claim 13, wherein the lithium salt is lithium bioxalato borate.

24. The electrolyte of claim 13, wherein the lithium salt is present in an amount from 1 to 20 mol %.
